(19) United States
(12) Patent Application Publication
(10) Pub. No.: US 2006/0217097 A1
(43) Pub. Date: Sep. 28, 2006

(54) Method and apparatus for radio communications in a wireless local area network

(75) Inventor: Hideyuki Nakagawa, Kunitachi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/444,304

(22) Filed: Jun. 1, 2006

Related U.S. Application Data
(63) Continuation of application No. PCT/JP04/18744, filed on Dec. 15, 2004.

(30) Foreign Application Priority Data
Dec. 26, 2003 (JP) 2003-433276

(51) Int. Cl. H04B 17/00

(52) U.S. Cl. 455/226.2; 455/67.11

(57) ABSTRACT

Disclosed herein is a radio communications apparatus that can monitor a radio environment and can display the level of interference of radio waves of the band assigned to the apparatus. The apparatus has a monitoring unit, a system control unit and an LED unit. The monitoring unit determines a radio-environment level from the strength of radio waves received. From the radio-environment level thus determined, the level of radio interference can be evaluated. The system control unit causes the LED unit to display the radio-environment level, i.e., the results of monitoring the radio environment.

### CROSS REFERENCE TO RELATED APPLICATIONS

This is a Continuation Application of PCT Application No. PCT/JP2004/018744, filed Dec. 15, 2004, which was published under PCT Article 21(2) in Japanese.

This application is based upon and claims the benefit of priority from Japanese Patent Application No. 2003-433276, filed Dec. 26, 2003, the entire contents of which are incorporated herein by reference.

### BACKGROUND

1. Field

The present invention generally relates to a radio communications apparatuses, and more particularly to a technique of monitoring radio interference in a radio communications environment.

2. Description of the Related Art

In recent years, radio communication systems using a frequency band known as “industrial, scientific and medical applications band (ISM band)” are increasingly employed in radio communication.

The ISM band is a frequency band used in various types of electronic devices and in short-range communication, too. The more data items are transmitted by radio using the ISM band, the more frequently radio interferences will occur. This inevitably worsens the radio communications environment. That is, the radio waves of various ISM-band frequencies interfere, while being transmitted between radio communications apparatuses. Consequently, the throughput of radio communication will decrease.

General users cannot exactly understand why the throughput of radio communication has decreased when they operate their radio communications apparatuses, such as personal digital assistants (PDAs), which have a radio communications device or a radio communications unit. This is because the user cannot know the radio interference, and also because the decrease in throughput may be attributed to the operating failure of the terminals or to the places where the terminals are used.

Radio communications apparatuses for general users will be very useful if they have a display that displays how much the radio waves of a specific band (e.g., ISM band) interfere with one another. A radio communications system has been proposed (see, for example, Jpn. Pat. Appln. KOKAI Publication No. 9-102766.) In this system, the each radio communications apparatus has a display that shows the conditions in which the apparatuses is receiving radio waves.

However, it is still difficult for general users to understand how the radio waves are interfering with one another, from the wave-receiving conditions displayed.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing the major components of a radio communications apparatus that is an embodiment of this invention;

FIG. 2 shows the data that the embodiment may display, showing the radio-environment level;

FIG. 3 is a graph representing the wave-receiving characteristic of the embodiment;

FIG. 4 is a graph illustrating the operation of the radio-environment monitoring unit incorporated in the embodiment;

FIG. 5 is a graph explaining how the radio-environment level is evaluated in the embodiment;

FIG. 6 is a flowchart depicting the sequence of monitoring the radio environment, which the embodiment performs; and

FIG. 7 is a block diagram of a radio communications apparatus that is another embodiment of this invention.

### DETAILED DESCRIPTION

Various embodiments according to the invention will be described hereinafter with reference to the accompanying drawings. In general, according to one embodiment of the invention, a radio communications apparatus which comprises: a receiving unit which receive radio waves; a detecting unit which detects the strength of the radio waves received by the receiving unit; a monitoring unit which monitors the radio-wave strength detected by the detecting unit, and which determines a radio-interference level from the strength of radio waves; and a display unit which displays data corresponding to the radio-interference level determined by the monitoring unit.

An embodiment of the invention will be described, with reference to the accompanying drawings.

(Configuration of the Apparatus)

FIG. 1 shows a radio communications apparatus according to this invention. The apparatus performs radio communication with other radio communications apparatuses, in a radio communications environment provided by, for example, a radio LAN. The apparatuses are, for example, radio communications devices for use in, for example, PDAs.

As FIG. 1 shows, the radio communications apparatus has an antenna 10, a radio unit 11, a base-band processing unit 12, a system control unit 13, a radio-environment monitoring unit 14, an LED control unit 15, and a display 16. The antenna 10 receives and transmits radio waves. The display 16 (hereinafter referred to as “LED unit”) comprises light-emitting diodes (LEDs). The LED control unit 15 drives and controls the LED unit 16.

The radio unit 11 is a so-called radio-frequency (FR) processing unit. It is a circuit designed to process the radio waves received at the antenna 10 and the radio waves to be transmitted from the antenna 10. It includes a received-signal strength indicator (RSSI) circuit.

The base-band processing unit 12 is a circuit that processes the digital signals converted from the radio waves received and the digital signals to be converted to radio waves that will be transmitted. (More precisely, the unit 12 modulates and demodulates digital signals.) The system control unit 13 includes a microprocessor (CPU) and a memory and is configured to control the other components of the radio communications apparatus.

As will be described later in detail, the radio-environment monitoring unit 14 is a component that monitors the interference of radio waves that fall within the frequency band of the apparatus. The unit 14 includes a microprocessor (CPU) and a memory and stores an application program for monitoring the radio environment. The system control unit 13 may assist the unit 14. In this case, the CPU incorporated in the system control unit 13 executes the application program.

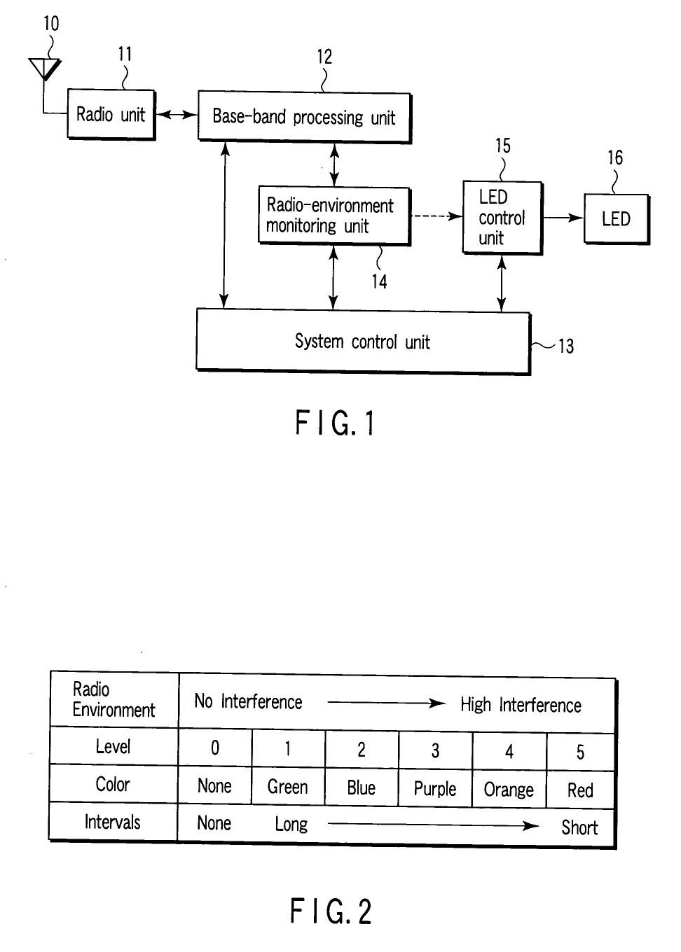

The LED control unit 15 and the LED unit 16 constitute a display device in the radio communications apparatus. When controlled by the system control unit 13, they display the radio-environment level (see FIG. 2) represented by the data output from the radio-environment monitoring unit 14.

(Monitoring of the Radio Environment)

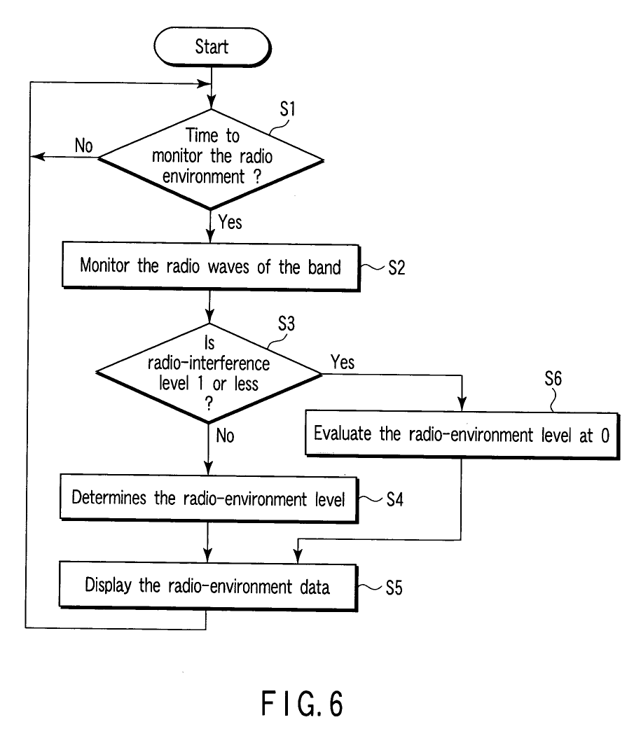

The sequence in which the radio-environment monitoring unit 14 performs its function will be described, with reference to the flowchart of FIG. 6.

The radio-environment monitoring unit 14 monitors the radio environment at regular intervals, each time in response to a signal form a timer. In other words, the unit 14 regularly monitors the radio environment, no matter whether the radio communications apparatus is communicating with any other radio communications apparatus. Upon receipt of a signal from the timer, the unit 14 starts monitoring the radio environment, i.e., radio-wave interference (if YES in Step S1).

As described above, the radio unit 11 includes an RSSI circuit. The RSSI circuit detects the strengths of the radio signals the antenna 10 has received. The radio unit 11 generates data representing the strengths of the radio signals. This data is supplied to the base-band processing unit 12. The unit 12 processes the data, which is supplied to the radio-environment monitoring unit 14. The unit 14 monitors the radio signals, i.e., radio waves that fall within the frequency band of the apparatus (Step S2). In practice, the unit 14 monitors the radio waves that fall within a band a little broader.

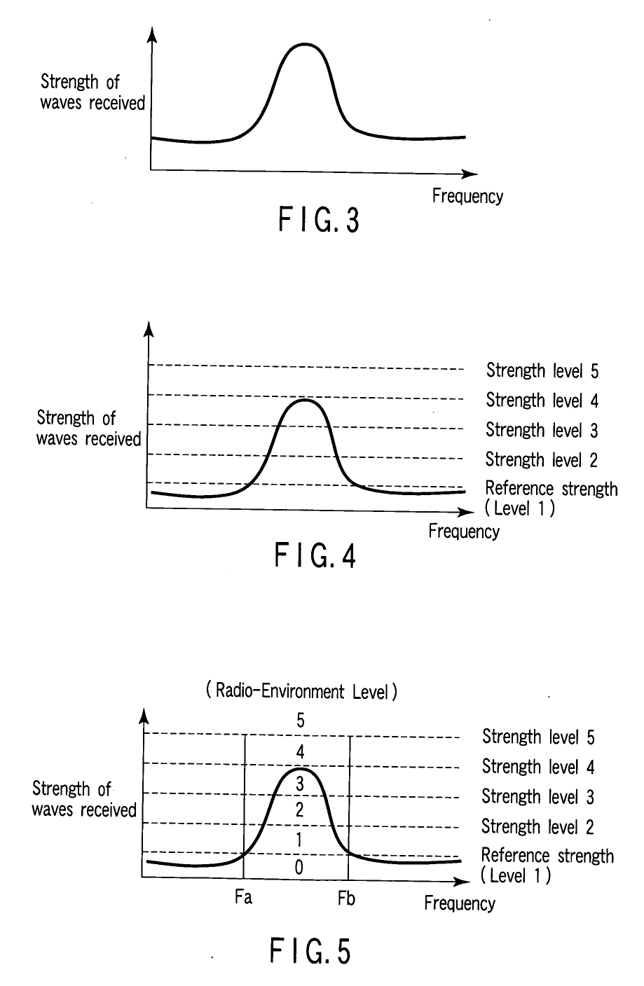

In other words, the radio-environment monitoring unit 14 acquires such data as shown in FIG. 3, from the radio unit 11 through the base-band processing unit 12. FIG. 3 is a graph representing the wave-receiving characteristic of the embodiment. In FIG. 3, frequencies are plotted on the x-axis, and the strengths of radio signals received are plotted on the y-axis.

The radio-environment monitoring unit 14 generates data representing the strengths of radio waves received, in terms of several levels. For example, the data can show five levels of radio-wave strength, level 1 indicating the reference strength. The reference level 1 corresponds to noise level and is used as threshold level. If a radio wave has strength above the threshold level, it may be interfered with any other radio waves. Hence, levels 2 to 5 indicate the degrees to which a radio wave may be interfered with any other radio waves.

From the data shown in FIG. 4, the radio-environment monitoring unit 14 detects the interference that the radio waves of the band of the apparatus (frequency Fa to frequency Fb) are undergoing with the radio waves of other bands. Then, the unit 14 determines the radio-environment level from the degree of the interference detected. (In the embodiment, the radio-environment level ranges from 0 to 5.)

More specifically, the radio-environment monitoring unit 14 determines whether the radio-interference level is 1 or less (Step S3). If YES in Step S3, the unit 14 evaluates the radio-environment level at 0 (FIG. 5) (Step S6). As seen from FIG. 2, the radio-environment level 0 means that the radio waves received are not interfered with any other radio waves.

If NO in Step S3, that is, if the level of interference exceeds 1, the radio-environment monitoring unit 14 determines the radio-environment level from the radio-interference level (Step S4). To be more specific, the unit 14 determines that the radio-environment level is 1 when the radio-interference level exceeds 1 but does not exceed 2, as is illustrated in FIG. 5. The unit 14 determines that the radio-environment level is 2 when the radio-interference level exceeds 2 but does not exceed 3. Likewise, the unit 14 determines radio-environment levels 3 to 5.

The radio-environment monitoring unit 14 generates data that represents the radio-environment level it has evaluated. This data is supplied to the system control unit 13. The system control unit 13 causes the LED control unit 15 to control the LED unit 16. Controlled by the unit 15, the LED unit 16 displays the radio-environment data (Step S5).

The LED 16 performs its function in accordance with the radio-environment level that ranges from 0 to 5. As shown in FIG. 2, the LED 16 displays nothing fi the radio-environment level is 0. If the radio-environment level 1, it emits green light. If the level is 2, it emits blue light. If the level is 3, it emits purple light. If the level 4, it emits orange light. If the level is 5, it emits red light. The LED 16 may operate in another mode. In this mode, it intermittently emits light (e.g., green light) in five different intervals, indicating the radio-environment levels 1 to 5, respectively.

The higher the radio-environment level determined, the higher the level of radio interference. Hence, the radio interference greatly reduces the throughput of radio communication when the radio-interference level is 5.

As specified above, the radio-environment monitoring unit 14 generates data that represents the radio-environment level it has determined from the radio-interference level detected. In accordance with this data, the system control unit 13 causes the LED control unit 15 to control the LED unit 16. The LED unit 16 emits light of a specific color or intermittently emits light at specific intervals, thus displaying the radio-environment level.

Assume that the radio communications apparatus is incorporated in, for example, a PDA. Then, the user of the PDA can know the radio-interference level, just looking at the LED 16 that automatically displays the radio-environment level. Now that the user knows the radio-environment level, he or she can predict a decrease in the throughput of radio communication, in accordance with the place and time in which and at which he or she is using the PDA.

As described above, the radio communications apparatus according to the embodiment monitors the radio interference, determines the radio-environment level from the radio interference and displays the radio-interference level. The user can visually perceive the radio interference and, hence, the radio-environment level.

(Another Embodiment)

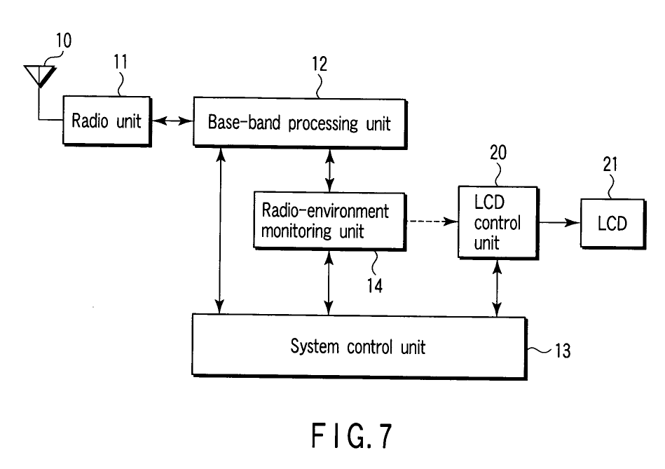

FIG. 7 is a block diagram of a radio communications apparatus that is another embodiment of this invention.

This embodiment is a radio communications apparatus (or a PDA). The apparatus is identical to the apparatus shown in FIG. 1, except that a liquid crystal display (LCD) 21 and an LCD control unit 20 are used in place of the LED control unit 15 and the LED 16.

In this embodiment, the LCD 21 displays an image or text data, representing the radio-environment level determined by the radio-environment monitoring unit 14. The user can more readily and correctly perceive the radio-interference level from the image or text data than from the color of light the LED 16 emits or the intervals at which the LED 16 intermittently emits light.

The present invention can provide a radio communications apparatus that has both the LED 16 and the LCD 21 and can operate in two display modes. In the first display mode, the LED 16 displays the radio-interference level. In the second display mode, the LCD 21 displays the radio-interference level. Moreover, the LED 16 or the LCD 21 may be replaced by any display that can display various level of radio interference.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A radio communications apparatus comprising:
a receiving unit which receives radio waves;
a detecting unit which detects the strength of the radio waves received by the receiving unit;
a monitoring unit which monitors the radio-wave strength detected by the detecting unit, and which determines a radio-interference level from the strength of radio waves; and
a display unit which displays data representing the radio-interference level determined by the monitoring unit.

2. The radio communications apparatus according to claim 1, wherein the monitoring unit uses the detecting unit, thereby scanning radio waves of a band assigned to the apparatus, and determines various radio-interference levels for the band, from the radio-wave strength detected by the detecting unit.

3. The radio communications apparatus according to claim 1, wherein the detecting unit performs a process of periodically detecting the strength of the radio waves.

4. The radio communications apparatus according to claim 1, wherein the display unit emits light of a specific color or intermittently emits light at specific intervals, to display the data representing the radio-interference level.

5. The radio communications apparatus according to claim 1, wherein the display unit displays data representing the radio-interference level, on a screen of a display device.

6. A method of monitoring a radio environment, for use in a radio communications apparatus which transmits and receives radio waves, the method comprising:
detecting the strength of radio waves received;
determining a radio-environment level from the detected strength of radio waves, said radio-environment level corresponding to a level of interference of the radio waves; and
displaying data representing the radio-environment level.

7. The method according to claim 6, wherein the monitoring of the radio environment is to detect the strength of radio waves of a band assigned, for a predetermined period, and determine the radio-environment level from the strength of radio waves of the band.

8. The method according to claim 6, wherein the displaying of data is to change the color of light emitted by a display device or the intervals at which the display device intermittently emits light, in accordance with the radio-environment level.

9. The method according to claim 6, wherein the displaying of data is to display data on a screen of a display device, said data representing a radio-interference level that corresponds to the radio-environment level.

10. The method according to claim 6, wherein the displaying of data is to display nothing on a screen of a display device when the radio-interference level is lower than a reference level, and to display the radio-environment levels in different manners, when the radio-interference level exceeds the reference level.
